(19) United States
(12) Patent Application Publication
(10) Pub. No.: US 2002/0075317 A1
(43) Pub. Date: Jun. 20, 2002

(54) System and method for an on-demand script-activated virtual keyboard

(75) Inventor: Glenn Dardick, Maidens, VA (US)

Correspondence Address: Greenberg Traurig, LLP, 12th Floor, 1750 Tysons Boulevard, McLean, VA, 22102, US

(73) Assignee: Dardick Technologies, Richmond, VA (US)

(21) Appl. No.: 09/866,494

(22) Filed: May 29, 2001

Related U.S. Application Data
(60) Provisional application No. 60/207,144, filed on May 26, 2000.

(51) Int. Cl. G09G 5/00

(52) U.S. Cl. 345/808

(57) ABSTRACT

A system and method for a virtual keyboard which may be used in lieu of a traditional, physical keyboard. Properties, methods, and hooks may be exposed by the present invention which allow programmers and web designers to create custom applications based on the present invention while customizing the behavior of the present invention to suit specific user-interface requirements.

This application claims the benefit of U.S. Provisional Patent Application No. 60/207,144 filed on May 26, 2000, the entire disclosure of which is incorporated herein by reference

This application is related to U.S. patent application Ser. No. 09/721,511 filed Nov. 22, 2000 and further related to U.S. Patent Application filed May 29, 2001 titled “System and Method For a Field Type Intelligent Web Portal” by inventor Glenn Dardick”; and U.S. Patent Application filed May 29, 2001 titled “System and Method For an On-Demand Script-Activated Selection Dialog Control” by inventor Glenn Dardick, the entire disclosures of which are incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of computer interface design, and, in particular, the present invention provides a software-based keyboard which may be activated through a touch-screen.

### BACKGROUND OF THE INVENTION

Computers are becoming increasingly prolific. From handheld organizers to notebook computers to Automated Teller Machines (ATMs) to information kiosks, computers are all around us. However, as computers continue to permeate our society, one overriding problem remains: how to create more intuitive human/computer interfaces.

For many years, keyboards and pointing devices, such as joysticks and mice, have been preferred for allowing humans to interact with computers. However, such input mechanisms require a significant learning curve, and are thus not well suited for devices such as kiosks and ATM machines which are used by the general public. The need for a more intuitive user-interface element has spurred the development of touch-sensitive display devices, such as that taught by U.S. Pat. No. 5,777,596 to Herbert.

As touch-sensitive displays have become increasingly popular, those designing handheld devices, kiosks, ATMs, and the like have created unique user-interfaces which structure interaction around visual elements on a touch-sensitive display. However, there are still some cases in which a keyboard, number pad, or other data-entry method is preferred. This is evidenced by such prior art as U.S. Pat. No. 6,008,799 to Van Kleeck, and U.S. Pat. No. 6,046,732 patent to Nishimoto.

### SUMMARY OF THE INVENTION

The present invention provides a customizable, software based keyboard which is projected on a touch-sensitive display and through which a user may enter character-based information, such as a name, address, telephone number, usemame, password, or other such information. The present invention may utilize software developed in a standardized programming language, such as, but not limited to JAVA or C++, to draw a keyboard on a display device and to read user input from such a device. The present invention may further be structured to allow access and control of the present invention by other software or hardware.

Such control may include, but is not limited to, displaying or hiding a number pad; displaying or hiding numbers above a keyboard; displaying or hiding specific keys or groups of keys; displaying or hiding special keys such as, but not limited to the Shift and Caps Lock keys; arranging keys alphabetically, based on the QWERTY arrangement of standard keyboards, or using other key arrangements; and limiting input string length.

### BRIEF DESCRIPTION OF THE DRAWINGS

FIG. 1 is a screen capture illustrating a traditional kiosk touch-screen which includes an E-mail subscription field.

FIG. 2 is a screen capture illustrating a traditional kiosk touch-screen to which the present invention has been added.

FIG. 3 is a screen capture illustrating a traditional kiosk touch-screen with data entered in the E-mail field.

### DETAILED DESCRIPTION OF THE PREFERRED EMBODIMENT

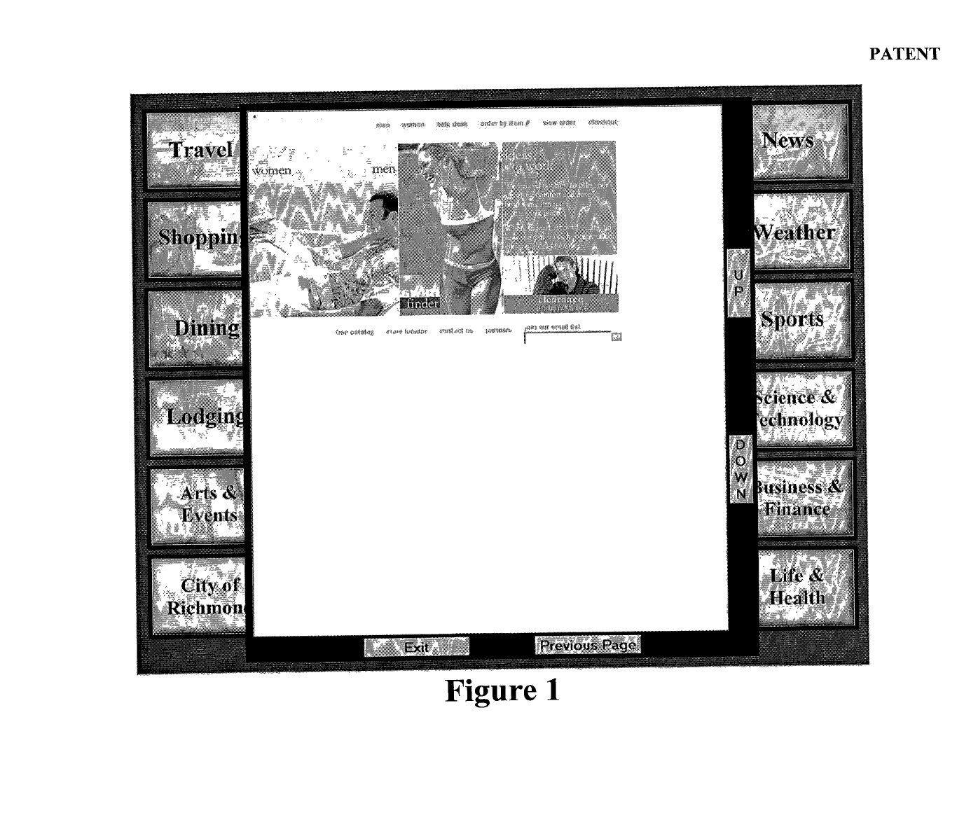

FIG. 1 is a screen capture illustrating a traditional kiosk touch-screen which includes an E-mail subscription field. In a preferred embodiment, a user wishing to subscribe to an E-mail list may touch the screen in the area of the E-mail field.

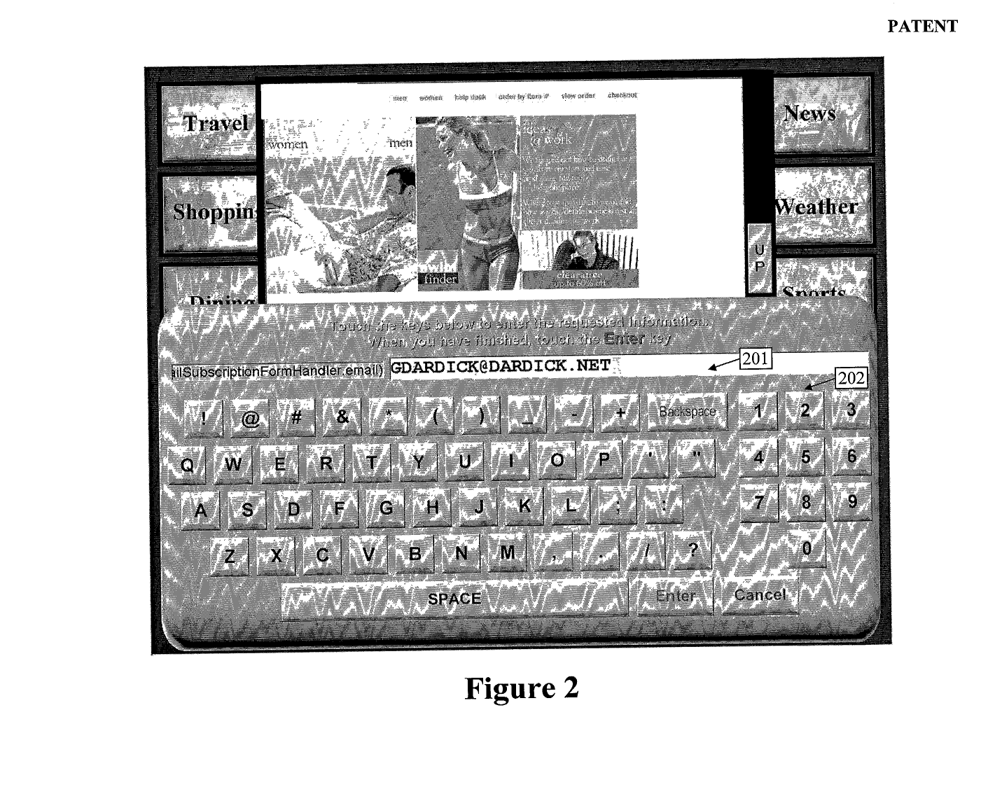

A software developer or web page designer may specify that the present invention should be displayed when a user interacts with a touch-screen display and selects a field into which numeric or character information may be entered. FIG. 2 is a screen capture illustrating a traditional kiosk touch-screen, on which the present invention is displayed.

As illustrated by FIG. 2, the present invention includes a software-based keyboard which may be customized to allow the entry of only those characters which are permissible for a given field type. As an example, without intending to limit the present invention, a user who is asked for a telephone number may be presented with only those keys corresponding to numerals, and keys for the “-”, “.”, “(”, and “)” characters. As an alternative example, as illustrated in FIG. 2, users entering E-mail addresses may be limited to letters, numbers, and those special characters which are permissible in an E-mail address.

The present invention represents an improvement over traditional, physical keyboards in many ways. For example, a virtual keyboard does not require any additional maintenance, while physical keyboards are additional pieces of hardware which may break and which are subject to vandalism. In addition, the present invention allows displayed key sizes to be customized, thereby improving the usability of a kiosk or other device by elderly individuals, or those visually or physically impaired.

The present invention may also provide advantages over physical keyboards by not making software intrusive keys available to users. Examples of such software intrusive keys include, under the Windows Operating System, the Windows key, the Right-Click key, and the Ctrl and Alt keys; and under the Macintosh Operating System, the Open-Apple and Command keys. On a physical keyboard, such keys may allow access to operating system functions which a software designer may wish to limit access.

The present invention represents an improvement over other virtual keyboards taught by the prior art in several ways. For example, in a preferred embodiment, the present invention may take the form of a computer program written in a standardized programming language such as JAVA, C++, or Visual Basic, and may be distributed as a code library. Such a distribution method may allow the present invention to be easily incorporated into other software, or added to web pages in the form of JAVA applets, ActiveX controls, or other such enhancements.

The present invention may further improve upon prior virtual keyboards by seamlessly integrating with a web browser or other software. For example, the present invention may be automatically launched by a web browser when a user activates a field, or when a script or other software requests information from a user. Further, the present invention may read attributes associated with an <INPUT>HTML tag, scripted procedure call, or other user input mechanism and automatically configure available keys, input string length, and other such features based on such attributes.

In addition, the present invention may improve upon prior virtual keyboards by automatically hiding when not in use. Such a feature allows a user to interact with a large keyboard when data entry is necessary, while maximizing available display area when a user is viewing images, interacting with buttons, or otherwise utilizing a touch-screen.

As illustrated by Block 201 of FIG. 2, the present invention may also include a text display area. Such a text display area may have a default value, as illustrated in FIG. 2, and the content of such a text display area may be modified by a software developer or web page designer.

The present invention may further contain a field in which a user may review entered data prior to submission, as illustrated by Block 202. A software developer or web page designer may specify a default value for such a field, thereby reducing the likelihood of data entry errors and improving the quality of the overall user-interface.

The present invention may also facilitate data entry error checking by providing built-in error checking routines from which a software developer or web designer may select, if such routines are desired. The present invention may further facilitate error checking by providing hooks into which a software developer or web page designer may insert custom error checking routines.

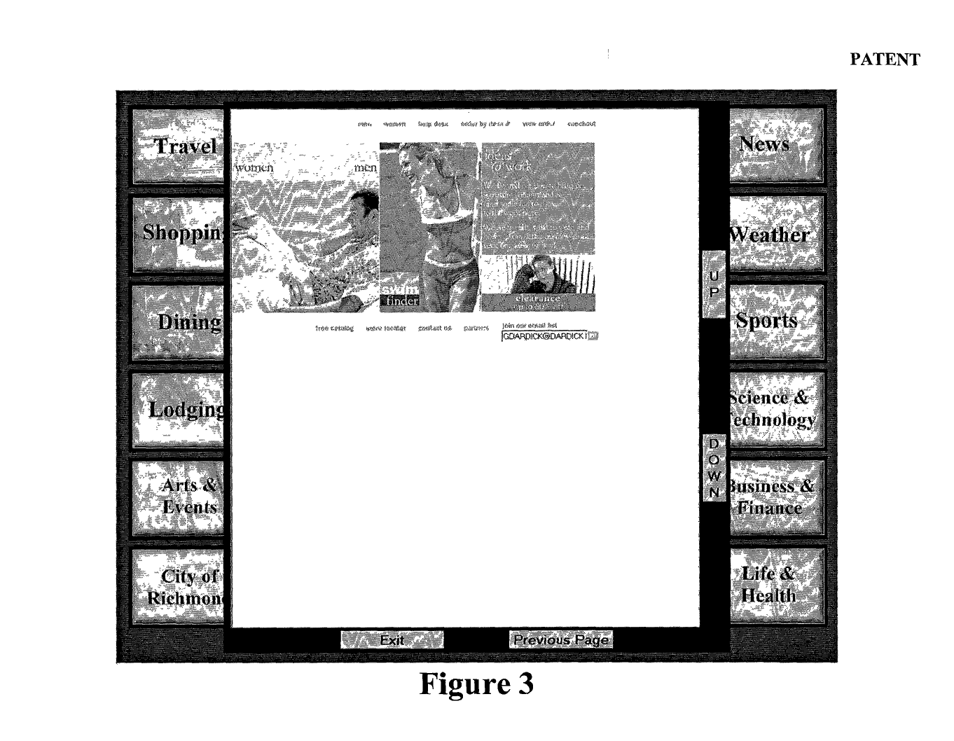

Once a user has submitted the requested information and the submitted information has been checked for errors (if requested by a software developer or web designer), the present invention may return the submitted information to the controlling application or web page, as illustrated by FIG. 3. FIG. 3 is a screen capture illustrating a traditional kiosk touch-screen with data entered in the E-mail field.

Appendix A shows an example of source code which is useful for practicing the present invention in accordance with a preferred embodiment. The present invention is particularly useful in combination with publicly accessible kiosks such as that taught in U.S. patent application Ser. No. 09/721,511 filed Nov. 22, 2000, the entire disclosure of which is incorporated herein by reference.

As should be apparent to one skilled in the art, the preceding discloses an improved touch-screen based keyboard. Although others in the prior art have utilized touch-screen based keyboards, the present invention represents an improvement upon the prior art by providing a platform-independent, software based keyboard which can be easily configured to match specific user-interface requirements.

While the preferred embodiment and various alternative embodiments of the invention have been disclosed and described in detail herein, it will be apparent to those skilled in the art that various changes in form and detail may be made therein without departing from the spirit and scope thereof.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

I claim:

1) In a computer system operable with selection controls, a virtual keyboard system comprising:
a control, wherein a virtual keyboard may be configured to appear upon the activation of the control; and
means for reading the control's attributes and for displaying the virtual keyboard according to the attributes.

2) The computer system of claim 1, further comprising means for providing a customizable interface wherein attributes of the virtual keyboard may be added, deleted or modified;

3) The computer system of claim 1, wherein the virtual keyboard contains a modifiable text display area.

4) The computer system of claim 1, wherein the virtual keyboard contains a review field.

5) The computer system of claim 1, wherein the virtual keyboard contains means for returning data to an underlying application.

6) The computer system of claim 5, wherein the data return means contain error checking procedures.

7) The computer system of claim 2, wherein the attributes include fields, keys, color and text.

8) The virtual keyboard of claim 1, wherein the virtual keyboard is platform-independent and distributable as a code library.

9) The virtual keyboard of claim 1, wherein the virtual keyboard may automatically hide from view on the display.

10) In a computer system operable with selection controls a method of interfacing with a computer system, comprising:
displaying a virtual keyboard upon the activation of a control; and
accepting inputted data; and
returning the inputted data to the underlying application.

11) A method according to claim 10, wherein the displaying of the virtual keyboard includes displaying a virtual keyboard that is configured according to the attributes of the control

12) A method according to claim 10, wherein the displaying of the virtual keyboard includes displaying a keyboard that is customized in its appearance.

13) A method according to claim 10, wherein the displaying of the virtual keyboard, includes a modifiable text display area.

14) A method according to claim 10, wherein the accepting of inputted data includes utilizing error checking routine(s).

15) A method according to claim 10, wherein the returning of inputted data is done after the inputted data has been checked for errors

16) A method according to claim 10, wherein the displaying of the virtual keyboard includes hiding the keyboard from view on the display.

17) A method according to claim 10, wherein the displaying of the virtual keyboard includes display upon the activation of a hardware or software control.

18) In a computer system operable with selection controls, a virtual keyboard system comprising:
a control, wherein a virtual keyboard may be configured to appear upon the activation of the control;
means for reading the control's attributes and for displaying the virtual keyboard according to the control's attributes;
means for providing a customizable interface wherein fields, keys, color and text of the virtual keyboard may be added, deleted or modified;
a modifiable text display area;
a review field, wherein a user of the virtual keyboard may review and modify data entries;
error checking routines; and
data routines, whereby data is returned to the underlying application.
